(19) United States
(12) Patent Application Publication
(10) Pub. No.: US 2022/0237669 A1
(43) Pub. Date: Jul. 28, 2022

(54) LoadUS Fundraising Web App

(71) Applicant: Shauniece Wallace, Atlanta, GA (US)

(72) Inventor: Shauniece Wallace, Atlanta, GA (US)

(21) Appl. No.: 17/374,539

(22) Filed: Jul. 13, 2021

Related U.S. Application Data
(60) Provisional application No. 63/141,909, filed on Jan. 26, 2021.

(51) Int. Cl. G06Q 30/02; G06Q 50/00; H04L 12/58

(52) U.S. Cl. CPC G06Q 30/0279; H04L 51/32; G06Q 50/01

(57) ABSTRACT

A system and method for providing a crowdsource fundraising web server-based application using a computing system communicatively coupled to a plurality of client computing devices over the Internet. The computing system includes a network connection to the Internet, a memory having instructions stored thereon, and a processor configured to execute the instructions to receive a request to create a fundraising campaign from a first user, create a first user fundraising campaign, store the first user fundraising campaign into a first set of a plurality of user fundraising campaigns, the first user fundraising campaign being stored within the first set of a plurality of user fundraising campaigns is sequential order, receive a donation for a second user fundraising campaign currently stored in a last set of user fundraising campaigns, when the second user fundraising campaign has received a defined number of donations, the second user fundraising campaign is removed from the last set of user fundraising campaigns and an oldest user fundraising campaign to the last set of user fundraising campaigns is move from the next lowest set of user fundraising campaigns, send user messages from the first user to other client computing devices assisting in obtaining donations to the second user fundraising campaign, and provide social networking services to the first user.

### CROSS-REFERENCE TO RELATED APPLICATION

This application claims priority to U.S. Patent Application No. 63/141,909, titled “LoadUS Fundraising Web App,” and filed on Jan. 26, 2021. The entire application is incorporated herein by reference in its entirety.

### TECHNICAL FIELD

This application relates in general to a system and method for providing a web server application, and more specifically, to a system and method for providing a crowdsource fundraising web server-based application.

### BACKGROUND

Many small businesses, non-profit entities, start-up enterprises, and similar organizations all typically encounter some level of difficulty in raising funds to create and grow their respective organizations. Recently, crowdsourcing has become a method applied to these fundraising efforts in which communities of individuals and organizations work together to raise initial funds for these efforts. This type of fundraising succeeds by gathering many small donations from across a community. As an organization is getting a campaign funded, the organizers of that particular campaign may give some back to the community by assisting in the fundraising efforts of others as well as making donations to other campaigns. This system is a continuation of circulation of funds inside of the community.

In order for these types of efforts to succeed, a community of individuals and organizations needs to be created, to grow, and to flourish. These efforts struggle as organizing such communities, providing mechanisms for the community members to communicate, and incentivizing active participation of community members all require designing, implementing, and utilizing processes used by members of the community. These processes typically require organization, recordkeeping, involvement monitoring of large numbers of individuals and organizations that may be collecting and documenting many small donations and vast amounts of communication and interaction between community members. Failure to support all of these tasks represents many obstacles to successful crowdsource fundraising efforts.

Therefore, a need exists for a system and method for providing a crowdsource fundraising web server-based application. The limitation and deficiencies in existing solutions are attempted to be overcoming according to principles and example embodiments as disclosed herein.

### SUMMARY

In accordance with the present invention, the above and other problems are solved by providing a system and method for a crowdsource fundraising web server-based application according to the principles and example embodiments disclosed herein.

In one embodiment, the present invention is a system providing a crowdsource fundraising web server-based application. The computing system includes a network connection to the Internet, a memory having instructions stored thereon, and a processor configured to execute the instructions to receive a request to create a fundraising campaign from a first user, create a first user fundraising campaign, store the first user fundraising campaign into a first set of a plurality of user fundraising campaigns, the first user fundraising campaign being stored within the first set of a plurality of user fundraising campaigns is sequential order, receive a donation for a second user fundraising campaign currently stored in a last set of user fundraising campaigns, when the second user fundraising campaign has received a defined number of donations, the second user fundraising campaign is removed from the last set of user fundraising campaigns and an oldest user fundraising campaign to the last set of user fundraising campaigns is move from the next lowest set of user fundraising campaigns, send user messages from the first user to other client computing devices assisting in obtaining donations to the second user fundraising campaign, and provide social networking services to the first user.

In another aspect of the present disclosure, the first user fundraising campaign is a fire list of user fundraising campaigns, all user fundraising campaigns are stored within the fire list of user fundraising campaigns is sequential order, a second user fundraising campaign is an air list of user fundraising campaigns, all user fundraising campaigns are stored within the air list of user fundraising campaigns is sequential order, a third user fundraising campaign is an earth list of user fundraising campaigns, all user fundraising campaigns are stored within the earth list of user fundraising campaigns is sequential order, and a fourth user fundraising campaign is a water list of user fundraising campaigns, the water list of user fundraising campaigns corresponds to the last set of user fundraising campaigns.

In another aspect of the present disclosure, an oldest user fundraising campaign on the fire list of fundraising campaigns is moved to the air list of fundraising campaign when a user fundraising campaign is removed from the air list of fundraising campaigns, an oldest user fundraising campaign on the fire list of fundraising campaigns is moved to the air list of fundraising campaign when a user fundraising campaign is removed from the air list of fundraising campaigns, an oldest user fundraising campaign on the air list of fundraising campaigns is moved to the earth list of fundraising campaign when a user fundraising campaign is removed from the earth list of fundraising campaigns, and an oldest user fundraising campaign on the earth list of fundraising campaigns is moved to the water list of fundraising campaign when a user fundraising campaign is removed from the air list of fundraising campaigns.

In another aspect of the present disclosure, the second user fundraising campaign is divided into two new user fundraising campaigns that are both added to the fire list of fundraising campaigns when the second user fundraising campaign is removed from the last set of user fundraising campaigns.

In another aspect of the present disclosure, the computing system provides users with a set of networking services, the networking services comprise a user chat function, a messaging function, and a business directory.

In another aspect of the present disclosure, the computing system receives donations for the users fundraising campaigns on the water list of fundraising campaigns and provides the donations to the user associated with the user fundraising campaign receiving the donations when the user fundraising campaign is removed from the water list of fundraising campaigns.

In another aspect of the present disclosure, the computing system acts as a web server communicating with the plurality of client computing devices using a web browser.

In another embodiment, the present invention is a method for providing a crowdsource fundraising web server-based application. A computing system is communicatively coupled to a plurality of client computing devices over the Internet, the computing system having a network connection to the Internet, a memory having instructions stored thereon and a processor configured to execute the instructions on the memory. The method receiving a request to create a fundraising campaign from a first user, creating a first user fundraising campaign, storing the first user fundraising campaign into a first set of a plurality of user fundraising campaigns, the first user fundraising campaign being stored within the first set of a plurality of user fundraising campaigns is sequential order, receives a donation for a second user fundraising campaign currently stored in a last set of user fundraising campaigns, when the second user fundraising campaign has received a defined number of donations, the second user fundraising campaign is removed from the last set of user fundraising campaigns and moves an oldest user fundraising campaign to the last set of user fundraising campaigns from the next lowest set of user fundraising campaigns, sends user messages from the first user to other client computing devices assisting in obtaining donations to the second user fundraising campaign, and provides social networking services to the first user.

In another embodiment of the present invention, a non-transitory computer-readable recording medium in a computing system for providing a crowdsource fundraising web server-based application, the non-transitory computer-readable recording medium storing one or more programs which when executed by a processor of the computing system performs steps of the methods described above.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates a system for providing a crowdsource fundraising web server-based application according to the present invention.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIG. 3 illustrates an example embodiment of a crowdsource fundraising web server-based application according to the present invention.

FIG. 4 illustrates a flowchart corresponding to a method performed by software components of a system providing a crowdsource fundraising web server-based application according to the present invention.

### DETAILED DESCRIPTION

This application relates in general to a system and method for providing a web server application, and more specifically, to a system and method providing a crowdsource fundraising web server-based application according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The term “mobile application” refers to an application executing on a mobile device such as a smartphone, tablet, and/or web browser on any computing device.

The terms “individual” and “user” refer to an entity, e.g., a human, using the LoadUS web-based fundraising application including any software or smart device application(s) associated with the invention. The term user herein refers to one or more users.

The term “connection,” refers to connecting any component as defined below by any means, including but not limited to, a wired connection(s) using any type of wire or cable for example, including but not limited to, coaxial cable(s), fiberoptic cable(s), and ethernet cable(s) or a wireless connection(s) using any type of frequency/frequencies or radio wave(s). Some examples are included below in this application.

The term “invention” or “present invention” refers to the invention being applied for via the patent application with the title “LoadUS Fundraising Web App.” Invention may be used interchangeably with LoadUS fundraising app.

The terms “communicate” or “communication” refer to any component(s) connecting with any other component(s) in any combination for the purpose of the connected components to communicate and/or transfer data to and from any components and/or control any settings.

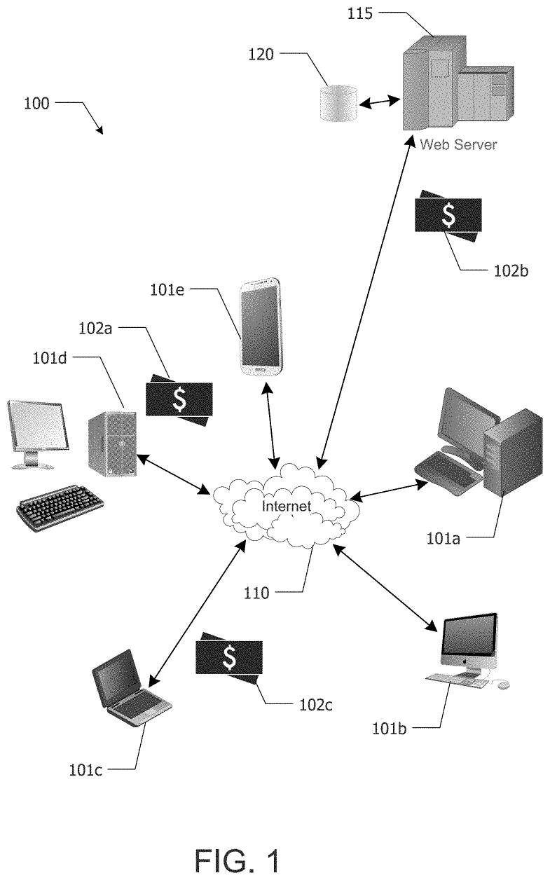

In general, the present disclosure relates to a system and method for providing a web server application. To better understand the present invention, FIG. 1 illustrates a system for providing a crowdsource fundraising web server-based application according to the present invention. A web-based crowdsource fundraising system 100 comprises a web server 115 communicatively connected to a plurality of community member computing devices 101a-c and a plurality of non-subscribing members computing devices 101d-e over the Internet 110. Community members join the community by logging into the web server 115 to create a profile, define a fundraising campaign, and engage other community members as part of fundraising efforts for all of the community's fundraising campaigns. Non-subscribing members are other individuals who visit the web server 115 to review and donate to one or more fundraising campaigns without becoming a member and creating a campaign. All of the community member user profiles, campaign records, and related user data may be maintained by the web server 115 on its local data storage devices 120.

A web application running on the web server 115 organizes each of these fundraising campaigns, ensures that each campaign operates within a community-based framework, and keeps track of the status and details of each campaign. Community members may locate each other via an online business directory of members 312, may interact with each other using a messaging system 313 within the web server 115, and may obtain additional community provided benefits 311 included with membership in the community.

Fundraising may proceed as members make donations 102a-c to one or more campaigns created by other community members. Community members also may assist each other in these fundraising activities by promoting each other's campaigns to interested parties who are or are not members of the community. In addition, a community member may advertise and share information regarding a particular fundraising campaign with non-subscribing members using e-mail, social media, and word of mouth. The community member may share a URL hyperlink to their fundraising campaign as part of the shared information providing access to the campaign on the web server 115. These non-subscribing members may make a ghost contribution to the particular user fundraising campaign that is provided in addition to contributions obtained from community members. In a preferred embodiment, the ghost contributions may be made in increments of $5.00 without placing them in the unique fundraising model of the present invention. The identity of the ghost donors automatically appears to show other community member users that the one fundraising campaign has reached the max limit of donations to become funded once the campaign becomes live.

The crowdsource fundraising system 100 creates incentives for members to assist each other in these efforts that increases the likelihood of success in the fundraising of all of the campaigns. One of the biggest needs in automated fundraising systems is to have mechanisms that drive donor traffic to the website and the individual fundraising campaigns contained therein. The present invention improves operation of the web server fundraising functions by creating an incentive for community members to work on behalf of each other and to cause contributions to made to fundraising campaigns supported by the web server 115. Because a particular campaign receives its funding once its particular campaign has made it through the process described herein that requires a particular number of contributions to other campaigns before the particular campaign is active and another number of contributions until the campaign ends and the funds are released, all community members benefit when other campaigns on the web server 115 are fully funded. As such, the Loadus system 100 causes the web server 115 to be more efficient in causing the fundraising campaigns of its members to be successful.

The invention, including its web server and client devices, may use any type of network such as a single network, multiple networks of a same type, or multiple networks of different types which may include one or more of a direct connection between devices, including but not limited to a local area network (LAN), a wide area network (WAN) (for example, the Internet), a metropolitan area network (MAN), a wireless network (for example, a general packet radio service (GPRS) network), a long term evolution (LTE) network, a telephone network (for example, a Public Switched Telephone Network or a cellular network), a subset of the Internet, an ad hoc network, a fiber optic network (for example, a fiber optic service (often known as FiOS) network), or any combination of the above networks.

Smart devices mentioned herein the present application may also use one or more sensors to receive or send signals, such as wireless signals for example, Bluetooth™, wireless fidelity, infrared, Wi-Fi, or LTE. Any smart device mentioned in this application may be connected to any other component or smart device via wired communications (e.g., conductive wire, coaxial cable, fiber optic cable, ethernet cable, twisted pair cable, transmission line, waveguide, etc.), or a combination of wired and wireless communications. The invention's method and/or system may use a single server device or a collection of multiple server devices and/or computer systems.

The systems and methods described above, may be implemented in many different forms of applications, software, firmware, and hardware. The actual software or smart device application codes or specialized control software, hardware or smart device application(s) used to implement the invention's systems and methods is not limiting of the implementation. Thus, the operation and behavior of the systems and methods were described without reference to the specific software or firmware code. Software, smart device application(s), firmware, and control hardware can be designed to implement the systems and methods based on the description herein.

This new invention also has the ability to provide crowdsource fundraising using a web server reachable by members of an online community. The members may utilize client devices including personal computers, laptop computers, tablets, smartphones and similar mobile devices to communicate with a web server. The fundraising activities, member communication, recordkeeping, and involvement monitoring all may occur on the web server with community members accessing its services remotely.

While all of the above functions are described to be provided to users via a mobile application on a smartphone, one of ordinary skill will recognize that any computing device including tablets, laptops, and general-purpose computing devices may be used as well. In at least one embodiment, all of the services described herein are provided using web pages being accessed from the web server 201 using a web browser such as Safari™, Firefox™, Chrome™ DuckDuckGo™, and the like. All of the screen examples described herein show user interface elements that provide the functionality of the present invention. The arrangement, organization, presentation, and use of particular user input/output (I/O) elements including hyperlinks, buttons, text fields, scrolling lists, and similar I/O elements are shown herein for example embodiments only to more easily convey the features of the present invention. The scope of the present invention should not be interpreted as being limited by any of these elements unless expressly recited within the attached claims.

For the purposes of the example embodiment of FIG. 1, various functions are shown to be performed on different programmable computing devices that communicate with each other over the Internet 110. These computing devices may include personal computers 101a-d, smartphones 101e, laptop computers 101c, tablets (not shown), and similar devices so long as the disclosed functionality of the mobile application described herein is supported by the particular computing device. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present invention. The attached claims recite any required combination of functionality onto a single machine, if required, and all example embodiments are for descriptive purposes.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects, and in order to more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method or algorithm is carried out or executed. Some steps may be omitted in some aspect or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example, an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines or other appropriate virtual environments).

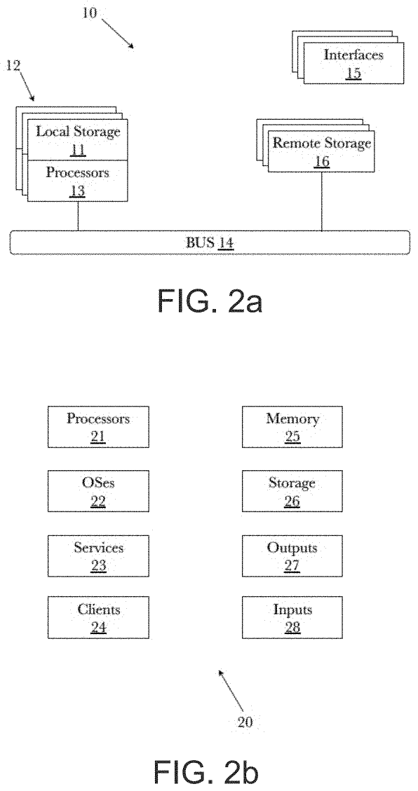

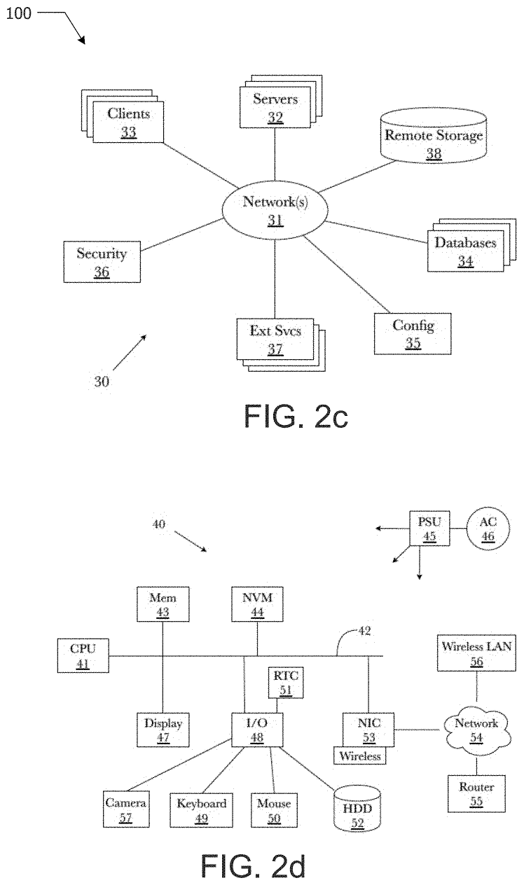

Referring now to FIG. 2a, there is a block diagram depicting an exemplary computing device 10 suitable for implementing at least a portion of the features or functionalities disclosed herein. A computing device 10 may be, for example, any one of the computing machines listed in the previous paragraph, or indeed any other electronic device capable of executing software- or hardware-based instructions according to one or more programs stored in memory. A computing device 10 may be configured to communicate with a plurality of other computing devices, such as clients or servers, over communications networks such as a wide area network, a metropolitan area network, a local area network, a wireless network, the Internet or any other network, using known protocols for such communication, whether wireless or wired.

In one aspect, a computing device 10 includes one or more central processing units (CPUs) 12, one or more interfaces 15, and one or more buses 14 (such as a peripheral component interconnect (PCI) bus). When acting under the control of appropriate software or firmware, the CPU 12 may be responsible for implementing specific functions associated with the functions of a specifically configured computing device or machine. For example, in at least one aspect, a computing device 10 may be configured or designed to function as a server system utilizing a CPU 12, local memory 11 and/or remote memory 16, and interface(s) 15. In at least one aspect, a CPU 12 may be caused to perform one or more of the different types of functions and/or operations under the control of software modules or components, which for example, may include an operating system and any appropriate applications software, drivers, and the like.

A CPU 12 may include one or more processors 13 such as for example, a processor from one of the Intel, ARM, Qualcomm, and AMD families of microprocessors. In some aspect, processors 13 may include specially designed hardware such as application-specific integrated circuits (ASICs), electrically erasable programmable read-only memories (EEPROMs), field-programmable gate arrays (FPGAs), and so forth, for controlling operations of a computing device 10. In a particular aspect, a local memory 11 (such as non-volatile random access memory (RAM) and/or read-only memory (ROM), including for example, one or more levels of cached memory) may also form part of a CPU 12. However, there are many different ways in which memory may be coupled to a system 10. Memory 11 may be used for a variety of purposes such as, for example, caching and/or storing data, programming instructions, and the like. It should be further appreciated that a CPU 12 may be one of a variety of system-on-a-chip-(SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may, for example, support other peripherals used with a computing device 10. Among the interfaces that may be provided are ethernet interfaces, frame relay interfaces, cable interfaces, DSL interfaces, token ring interfaces, graphics interfaces, and the like. In addition, various types of interfaces may be provided such as, for example, universal serial bus (USB), serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast ethernet interfaces, gigabit ethernet interfaces, serial ATA (SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interfaces (HSSI), point of sale (POS) interfaces, fiber data distributed interfaces (FDDIs), and the like. Generally, such interfaces 15 may include physical ports appropriate for communication with appropriate media.

In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and a server system (such as a server system described in more detail below).

Regardless of network device configuration, the system of an aspect may employ one or more memories or memory modules (for example, remote memory block 16 and local memory 11) configured to store data, program instructions for the general-purpose network operations or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information or any other specific or generic non-program information described herein.

Because such information and program instructions may be employed to implement one or more systems or methods described herein, at least some network device aspects may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device) or they may be removable such as swappable flash memory modules (such as “thumb drives” or other removable media designed for rapidly exchanging physical storage devices), “hot-swappable” hard disk drives or solid state drives, removable optical storage disks, or other such removable media, and that such integral and removable storage media may be utilized interchangeably. Examples of program instructions include both object code, such as may be produced by a compiler, machine code, such as may be produced by an assembler or a linker, byte code, such as may be generated by for example by a JAVA™ compiler and may be executed using a JAVA™ virtual machine or equivalent, or files containing higher level code that may be executed by the computer using an interpreter (for example, scripts written in Python™, Perl™, Ruby™, Groovy™, or any other scripting language).

In some aspects, systems may be implemented on a standalone computing system. Referring now to FIG. 2b, there is a block diagram depicting a typical exemplary architecture of one or more aspects or components thereof on a standalone computing system. A computing device 20 includes processors 21 that may run software that carry out one or more functions or applications of aspects, such as for example a client application 24. Processors 21 may carry out computing instructions under control of an operating system 22 such as for example, a version of MICROSOFT WINDOWS™ operating system, APPLE macOS™ or iOS™ operating systems, some variety of the LINUX™ operating system, ANDROID™ operating system, or the like. In many cases, one or more shared services 23 may be operable in a system 20, and may be useful for providing common services to client applications 24. Services 23 may, for example, be WINDOWS™ services, user-space common services in a LINUX™ environment or any other type of common service architecture used with an operating system 22. Input devices 28 may be of any type suitable for receiving user input including, for example, a keyboard, touchscreen, microphone (for example, for voice input), mouse, touchpad, trackball or any combination thereof. Output devices 27 may be of any type suitable for providing output to one or more users, whether remote or local to system 20 and may include, for example, one or more screens for visual output, speakers, printers or any combination thereof. Memory 25 may be RAM having any structure and architecture known in the art for use by processors 21, for example to run software. Storage devices 26 may be any magnetic, optical, mechanical, memristor or electrical storage device for storage of data in digital form (such as those described above, referring to FIG. 2a). Examples of storage devices 26 include flash memory, magnetic hard drive, CD-ROM, and the like.

In some aspects, systems may be implemented on a distributed computing network, such as one having any number of clients and/or servers. Referring now to FIG. 2c, there is a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 2b. In addition, any number of servers 32 may be provided for handling requests received from one or more clients 33. Clients 33 and servers 32 may communicate with one another via one or more electronic networks 31, which may be in various aspects any Internet, wide area network, mobile telephony network (such as CDMA or GSM cellular networks), wireless network (such as WiFi, WiMAX, LTE, and so forth) or local area network (or indeed any network topology known in the art; the aspect does not prefer any one network topology over another). Networks 31 may be implemented using any known network protocols, including, for example, wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored on a server system 32 in the Cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web system. It should be understood by one having ordinary skill in the art that any configuration or security subsystems known in the art now or in the future may be used in conjunction with aspects without limitation, unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to a computer system 40 without departing from the broader scope of the system and method disclosed herein. A CPU 41 is connected to bus 42, to which bus is also connected to memory 43, non-volatile memory 44, display 47, I/O unit 48, and network interface card (NIC) 53. An I/O unit 48 typically may be connected to peripherals such as a keyboard 49, pointing device 50, hard disk 52, real-time clock 51, camera 57, and other peripheral devices. A NIC 53 connects to a network 54, which may be the Internet or a local network, which local network may or may not have connections to the Internet. The system may be connected to other computing devices through the network via a router 55, wireless local area network 56 or any other network connection. Also shown as part of a system 40 is a power supply unit 45 connected, in this example, to a main alternating current (AC) supply 46. Not shown are batteries that could be present and many other devices and modifications that are well known, but are not applicable to, the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

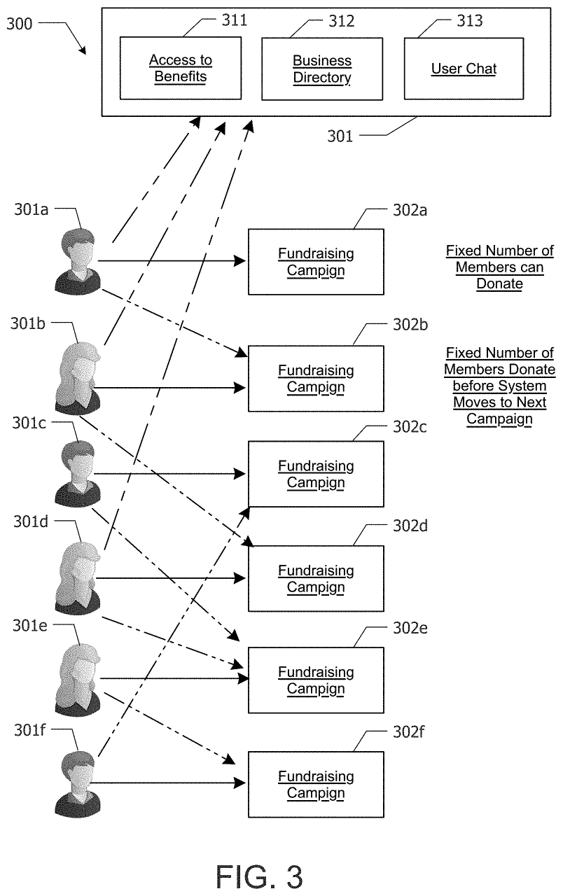

FIG. 3 illustrates an example embodiment of a crowdsource fundraising web server-based application according to the present invention. Using the crowdsource fundraising system 100, community members 301a-f join the community by creating a profile on the web server 115. Each member 301a-f may create a fundraising campaign profile 302a-f that may be organized into groups of users. Each campaign profile 302a-f describes the campaign, the individuals or organization seeking the fundraising, a statement of the intended purposes of the funds, and any relevant information provided to encourage support of the campaign. Each group of campaigns may define campaign parameters, donation amounts, and any desired requirements for the campaign operations and uses.

These campaign profiles 302a-f are stored within the web server 115 and are searchable by members of the community and any users invited by community members to contribute. In order to cause their own fundraising campaign to be active, the community members must participate in assisting other campaigns. A member begins membership by signing up, signing in and paying any required fees. If a new member was invited by a specific user or group, the new member may search directly for that group or user's campaign. Each campaign is unique to each member. In the campaign profile 302a-f campaigns are not designed for immediate funding, but rather designed more for longevity and building generational wealth or even saving for a future endeavor or milestone. Only live campaigns are open for immediate fundraising.

Once a member finds a campaign that they choose to donate to, they will donate the specific amount to the campaign organizer. Only 8 donors can give to a live campaign at a time. Each campaign in each level has a different donation amount. That amount is highlighted in the description of each group that houses all campaigns. Before a campaign goes live, the user's campaign waits its turn on a waiting list, referred to as a fire list. When the user's campaign is first created and the user makes a donation, the user's campaign is added to the end of the fire list. After the each of the campaigns ahead of the user's campaign moves up to the water list, the user's campaign becomes a water campaign in which it is a live campaign to receive donations.

When the user's campaign moves through the waiting list, each campaign holds 7 previous donors that have moved a position and work together to assist the campaign organizers in getting fully funded. The position of the various user campaigns are transparent waiting periods that track each member's progress. The members can enjoy the many amenities of the app while they wait for their campaigns to go live. The app also gives each individual campaign collective the ability to invite others to give to that campaign no matter where they are in line, while others can wait for the community to assist. It's synonymous to a group project, where a small group must assist one another toward a common goal. They can share to their social media or other families and friends.

Once a member gives to another campaign, the system 100 automatically places that member's campaign in a unique linear process for members to be able to showcase a particular campaign and collect a specific amount of donations from a limited number of people. The present invention defines a specific sequence of interactions of members before any particular campaign is funded to encourage members to assist in other member's campaigns.

A campaign organizer receives one donation. This donation must be given to another live campaign within the same group before they can receive an additional 7 donations.

This donation does not place them in the linear process again. This is a pure gift or donation. This requirement is the key to sustainability. As more and more pure gifts/donations (ghost positions) land on a live campaign, this creates less of a need for more new people to join and donate to allow everyone to move through the unique linear process.

Once the campaign has fully received funds from 8 different members, the organizer has reached their full funding goal and the campaign closes, splitting into two different/new live campaigns and goes toward the back of the line on the fire list. Every waiting campaign moves up a position on the line getting closer to being able to have their campaign go live and get fully funded. This happens continuously until those ghost positions fully dissolve the campaign's linear process. This process has no time span as it is community funded and community participation-based. The goal is to continue to strategically circulate funds amongst all & any member who decides to join, giving each member the ability to raise funds from the community once it's their turn.

A newly created campaign passes through a set of stages before becoming live to receive donations. The campaign starts as a fire stage campaign after the member makes a contribution to one live campaign. Any campaign waiting to go live is considered a flower campaign. A flower campaign is where members can see where they are in line that the system automatically places them in. By contrast, a water campaign is when the member's campaign is live and able to receive donations from the collective of community members.

Members may invite other users to join at 8 fire level positions in a flower campaign to complete a flower campaign and allow other users apart of that campaign to move in a linear manner. When a flower campaign receives 8 fire campaigns, the member's campaign progresses to becoming a water campaign and be live to accept donations.

Users would be able to view the group pool where they can view the list of flower campaigns and request to add them to it. Also, at any point in time, users can request to exit the group and flower campaign. While users wait for their campaigns to go live, they have the ability to explore the business directory 312 that consists of small business all over the world. The members that make up the directory 312 can range from members that are a part of flower campaigns or just anyone who is interested in showcasing their business to hundreds of thousands of users.

Users may also utilize Loadus benefits 311 that are available to members. These benefits may include healthcare, rent and utility assistance, personal and business finance training, and other services and discounts made available to community members. For example, in a preferred embodiment, the Loadus benefits 311 many include United health care plans, HCCUA, telemedicine, mental health, dental and vision legal shield. They can also get access to a free discounts and perks and coupons from Loadus partners. Discounts on movies, pizza, groceries, electronics. and hundreds of thousands other items.

A chat or messenger 313 is also provided to permit users to communicate with each other. The messenger also gives members the ability to communicate amongst donors and campaign organizers. Members also will be able to chat and network amongst each other across the entire platform as long as they have each other's name, email, and their user IDs. Those user IDs will be showcased to all members who join the business directory. Group chat rooms are also available for members who want to create small groups and chat amongst each other.

The users may access a Loadus employment benefit 314 and a Loadus Library 315. The Loadus employment benefit 314 provides a directory list of all the jobs we have available. Our staffing agency partner and also COO has thousands of remote positions to aid our members during hard times. We also provide training to prepare them for hire, resume building, ect. There is a link there for the lm to click on, read criteria, and apply.

The Loadus Library 315 enables community member users to access to financial literacy videos and information both personal and business. The Loadus Library 315 also gives users tips and access to capital. The Loadus Library 315 assist users with the fundamentals of having a small business and all the paperwork required to make sure these businesses qualify for funding. Credit repair services are available for both business and personal credit reports. The Loadus Library 315 may include monthly Loadus magazines that are available to community member users.

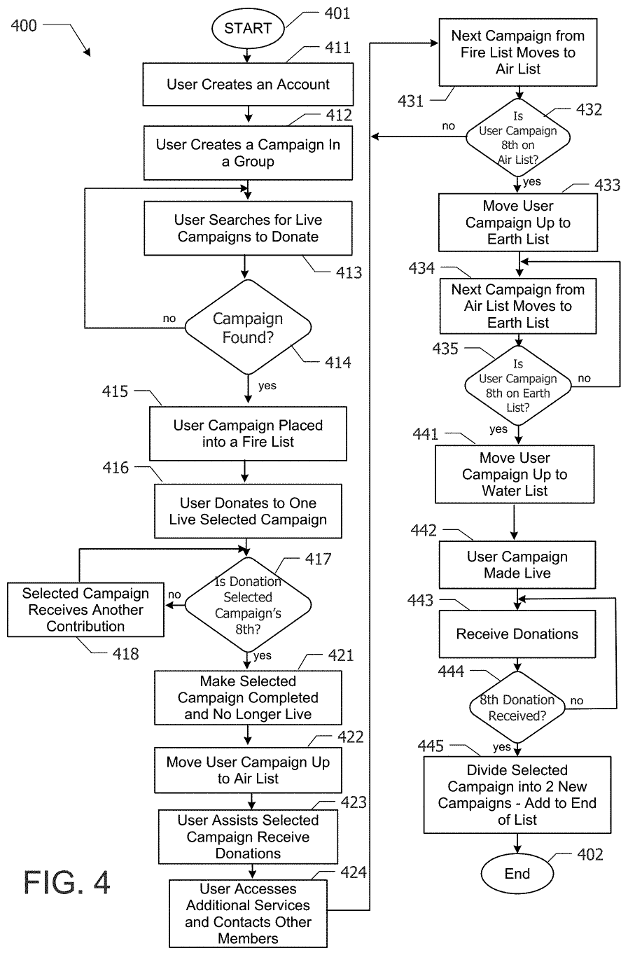

FIG. 4 illustrates a flowchart corresponding to a method performed by software components of a system providing a crowdsource fundraising web server-based application according to the present invention. The process 400 begins with a user signing up with the web server 115 in step 411. The user may create a fundraising campaign in step 412 and search for a live campaign to make a donation in step 413. Test step 414 determines whether a campaign has been found to make a donation, and if not, the process 400 returns to step 413 to continue searching.

When test step 414 determines that a live campaign has been selected by a user to make a donation, the user's campaign is placed onto a fire campaign list in step 415 and the user makes a donation to the selected live campaign in step 416. Test step 417 determines whether the user's campaign has received a ghost donation; and if not, the process continues to test step 419 to determine whether an 8^{th} donation has been received. When test step 417 determines that the user campaign has received a ghost donation, the user campaign is credited with the donation in step 418 before the process 400 continues to test step 419 as well. Test step 419 determines whether the donation made to the selected campaign is the 8^{th} donation, and if not, the selected campaign waits in step 420 to receive another donation before returning to test step 417.

When test step 419 determines that the 8^{th} donation has been received, the selected campaign is completed in step 421 and is made no longer live. The user campaign is moved to the water campaign list in step 422. The user confirms the selected campaign received donations in step 423, and in step 424 the user accesses additional services and contacts other members of the community.

In step 431, the user's campaign is made live to permit the user's campaign to receive donations in step 443. Test step 441 determines whether the user's campaign has received a ghost donation; and if not, the process continues to step 443 to await another campaign donation. When test step 441 determines that the user campaign has received a ghost donation, the user campaign is credited with the donation in step 442 before the process 400 continues to step 443 to await a donation from a community user member. Once a donation from a community user member is received, test step 444 determines if the user's campaign has received the 8^{th} donation, and if not, the process returns to step 441.

When test step 444 determines that the user's campaign has received the 8^{th} donation, the process 400 makes the user campaign completed and splits the campaign into two new campaigns, in step 445 that are both added to the end of the fire list for proceeding towards funding and the process ends 402.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise. Any singular term used in this present patent application is applicable to its plural form even if the singular form of any term is used.

In the present application, all or any part of the invention's software or application(s) or smart device application(s) may be installed on any of the user's or operator's smart device(s), any server(s) or computer system(s) or web application(s) required to allow communication, control (including but not limited to control of parameters, settings such as for example, sign copy brightness, contrast, ambient light sensor settings . . . etc.), transfer of content(s) or data between any combination of the components.

What it claimed is:

1. A computing system for social networking and fundraising between a plurality of users, the computing system communicatively coupled to a plurality of client computing devices over the Internet, the computing system comprising:
a network connection to the Internet;
a memory having instructions stored thereon; and
a processor configured to execute the instructions on the memory to cause the computing system to:
receive a request to create a fundraising campaign from a first user;
create a first user fundraising campaign;
store the first user fundraising campaign into a first set of a plurality of user fundraising campaigns, the first user fundraising campaign being stored within the first set of a plurality of user fundraising campaigns is sequential order;
receive a donation for a second user fundraising campaign currently stored in a last set of user fundraising campaigns;
when the second user fundraising campaign has received a defined number of donations, the second user fundraising campaign is removed from the last set of user fundraising campaigns and an oldest user fundraising campaign to the last set of user fundraising campaigns is move from the next lowest set of user fundraising campaigns;
send user messages from the first user to other client computing devices assisting in obtaining donations to the second user fundraising campaign; and
provide social networking services to the first user.

2. The computing system according to claim 1, wherein the first user fundraising campaign is a fire list of user fundraising campaigns, all user fundraising campaigns are stored within the fire list of user fundraising campaigns is sequential order;
a second user fundraising campaign is an air list of user fundraising campaigns, all user fundraising campaigns are stored within the air list of user fundraising campaigns is sequential order;
a third user fundraising campaign is an earth list of user fundraising campaigns, all user fundraising campaigns are stored within the earth list of user fundraising campaigns is sequential order; and
a fourth user fundraising campaign is a water list of user fundraising campaigns, the water list of user fundraising campaigns corresponds to the last set of user fundraising campaigns.

3. The computing system according to claim 2, wherein an oldest user fundraising campaign on the fire list of fundraising campaigns is moved to the air list of fundraising campaign when a user fundraising campaign is removed from the air list of fundraising campaigns;
an oldest user fundraising campaign on the fire list of fundraising campaigns is moved to the air list of fundraising campaign when a user fundraising campaign is removed from the air list of fundraising campaigns;
an oldest user fundraising campaign on the air list of fundraising campaigns is moved to the earth list of fundraising campaign when a user fundraising campaign is removed from the earth list of fundraising campaigns; and
an oldest user fundraising campaign on the earth list of fundraising campaigns is moved to the water list of fundraising campaign when a user fundraising campaign is removed from the air list of fundraising campaigns.

4. The computing system according to claim 3, wherein the second user fundraising campaign is divided into two new user fundraising campaigns that are both added to the fire list of fundraising campaigns when the second user fundraising campaign is removed from the last set of user fundraising campaigns.

5. The computing system according to claim 1, wherein the computing system provides users with a set of networking services, the networking services comprise a user chat function, a messaging function, and a business directory.

6. The computing system according to claim 5, wherein the computing system receives donations for the users fundraising campaigns on the water list of fundraising campaigns and provides the donations to the user associated with the user fundraising campaign receiving the donations when the user fundraising campaign is removed from the water list of fundraising campaigns.

7. The computing system according to claim 1, wherein the computing system acts as a web server communicating with the plurality of client computing devices using a web browser.

8. A method for social networking and fundraising between a plurality of users, a computing system communicatively coupled to a plurality of client computing devices over the Internet, the computing system having a network connection to the Internet, a memory having instructions stored thereon and a processor configured to execute the instructions on the memory to perform method steps, the method comprising:
receiving a request to create a fundraising campaign from a first user;
creating a first user fundraising campaign;
storing the first user fundraising campaign into a first set of a plurality of user fundraising campaigns, the first user fundraising campaign being stored within the first set of a plurality of user fundraising campaigns is sequential order;
receiving a donation for a second user fundraising campaign currently stored in a last set of user fundraising campaigns;
when the second user fundraising campaign has received a defined number of donations, the second user fundraising campaign is removed from the last set of user fundraising campaigns and moving an oldest user fundraising campaign to the last set of user fundraising campaigns from the next lowest set of user fundraising campaigns;
sending user messages from the first user to other client computing devices assisting in obtaining donations to the second user fundraising campaign; and
providing social networking services to the first user.

9. The method according to claim 8, wherein the first user fundraising campaign is a fire list of user fundraising campaigns, all user fundraising campaigns are stored within the fire list of user fundraising campaigns is sequential order;
a second user fundraising campaign is an air list of user fundraising campaigns, all user fundraising campaigns are stored within the air list of user fundraising campaigns is sequential order;
a third user fundraising campaign is an earth list of user fundraising campaigns, all user fundraising campaigns are stored within the earth list of user fundraising campaigns is sequential order;
a fourth user fundraising campaign is a water list of user fundraising campaigns, the water list of user fundraising campaigns corresponds to the last set of user fundraising campaigns.

10. The method according to claim 9, wherein an oldest user fundraising campaign on the fire list of fundraising campaigns is moved to the air list of fundraising campaign when a user fundraising campaign is removed from the air list of fundraising campaigns;
an oldest user fundraising campaign on the fire list of fundraising campaigns is moved to the air list of fundraising campaign when a user fundraising campaign is removed from the air list of fundraising campaigns;
an oldest user fundraising campaign on the air list of fundraising campaigns is moved to the earth list of fundraising campaign when a user fundraising campaign is removed from the earth list of fundraising campaigns; and
an oldest user fundraising campaign on the earth list of fundraising campaigns is moved to the water list of fundraising campaign when a user fundraising campaign is removed from the air list of fundraising campaigns.

11. The method according to claim 10, wherein the second user fundraising campaign is divided into two new user fundraising campaigns that are both added to the fire list of fundraising campaigns when the second user fundraising campaign is removed from the last set of user fundraising campaigns.

12. The method according to claim 8, wherein computing system provides users with a set of networking services, the networking services comprise a user chat function, a messaging function, and a business directory.

13. The method according to claim 12, wherein the computing system receives donations for the users fundraising campaigns on the water list of fundraising campaigns and provides the donations to the user associated with the user fundraising campaign receiving the donations when the user fundraising campaign is removed from the water list of fundraising campaigns.

14. The method according to claim 8, wherein the computing system acts as a web server communicating with the plurality of client computing devices using a web browser.

15. A non-transitory computer-readable recording medium in a computing system for social networking and fundraising between a plurality of users, a computing system communicatively coupled to a plurality of client computing devices over the Internet, the computing system having a network connection to the Internet, a memory having instructions stored thereon and a processor configured to execute the instructions on the memory, the non-transitory computer-readable recording medium storing one or more programs which when executed by the processor of the computing system performs steps comprising:
receiving a request to create a fundraising campaign from a first user;
creating a first user fundraising campaign;
storing the first user fundraising campaign into a first set of a plurality of user fundraising campaigns, the first user fundraising campaign being stored within the first set of a plurality of user fundraising campaigns is sequential order;
receiving a donation for a second user fundraising campaign currently stored in a last set of user fundraising campaigns;
when the second user fundraising campaign has received a defined number of donations, removing the second user fundraising campaign from the last set of user fundraising campaigns and moving an oldest user fundraising campaign to the last set of user fundraising campaigns from the next lowest set of user fundraising campaigns;
sending user messages from the first user to other client computing devices assisting in obtaining donations to the second user fundraising campaign; and
providing social networking services to the first user.

16. The computer-readable recording medium according to claim 15, wherein the first user fundraising campaign is a fire list of user fundraising campaigns, all user fundraising campaigns are stored within the fire list of user fundraising campaigns is sequential order;
a second user fundraising campaign is an air list of user fundraising campaigns, all user fundraising campaigns are stored within the air list of user fundraising campaigns is sequential order;
a third user fundraising campaign is an earth list of user fundraising campaigns, all user fundraising campaigns are stored within the earth list of user fundraising campaigns is sequential order;
a fourth user fundraising campaign is a water list of user fundraising campaigns, the water list of user fundraising campaigns corresponds to the last set of user fundraising campaigns.

17. The computer-readable recording medium according to claim 16, wherein an oldest user fundraising campaign on the fire list of fundraising campaigns is moved to the air list of fundraising campaign when a user fundraising campaign is removed from the air list of fundraising campaigns;
an oldest user fundraising campaign on the fire list of fundraising campaigns is moved to the air list of fundraising campaign when a user fundraising campaign is removed from the air list of fundraising campaigns;
an oldest user fundraising campaign on the air list of fundraising campaigns is moved to the earth list of fundraising campaign when a user fundraising campaign is removed from the earth list of fundraising campaigns;
an oldest user fundraising campaign on the earth list of fundraising campaigns is moved to the water list of fundraising campaign when a user fundraising campaign is removed from the air list of fundraising campaigns; and
the second user fundraising campaign is divided into two new user fundraising campaigns that are both added to the fire list of fundraising campaigns when the second user fundraising campaign is removed from the last set of user fundraising campaigns.

18. The computer-readable recording medium according to claim 15, wherein computing system provides users with a set of networking services, the networking services comprise a user chat function, a messaging function, and a business directory.

19. The computer-readable recording medium according to claim 18, wherein the computing system receives donations for the users fundraising campaigns on the water list of fundraising campaigns and provides the donations to the user associated with the user fundraising campaign receiving the donations when the user fundraising campaign is removed from the water list of fundraising campaigns.

20. The computer-readable recording medium according to claim 15, wherein the computing system acts as a web server communicating with the plurality of client computing devices using a web browser.
